(19) United States
(12) Patent Application Publication
(10) Pub. No.: US 2025/0321149 A1
(43) Pub. Date: Oct. 16, 2025

(54) SELF-CHARGING LOAD CELL

(71) Applicants: Paul Nash, Lamont, IA (US); James Nash, Marion, IA (US)

(72) Inventors: Paul Nash, Lamont, IA (US); James Nash, Marion, IA (US)

(21) Appl. No.: 18/634,909

(22) Filed: Apr. 13, 2024

(51) Int. Cl. G01L 1/26; G01L 1/16

(52) U.S. Cl. CPC G01L 1/26; G01L 1/16

(57) ABSTRACT

A self-charging load cell, including a main body to at least partially deform in response to an application of force thereto, a piezoelectric actuator disposed within at least a portion of the main body to generate power in response to the main body at least partially deforming, and a power unit disposed within at least a portion of the main body to store the power generated by the piezoelectric actuator and transmit the power to an external device.

### BACKGROUND

### 1. Field

The present general inventive concept relates generally to a load cell, and particularly, to a self-charging load cell.

### 2. Description of the Related Art

A load cell is a type of force transducer to convert a force into an electrical signal that can be measured. One of the most common applications of the load cell is a strain gauge. The strain gauge is highly accurate. Typically, the strain gauge uses a spring element property of steel and/or aluminum to measure an amount of force based on a voltage generated from the force applied.

However, troubleshooting and/or repairing the load cell, also known as a weigh bar, can be difficult. A failed load cell would need to be stripped to a blank load cell condition, verified, and then have new electronics installed in order to reestablish its functionality. Moreover, the load cell is prone to failure as a result of repetitive loadings, as well as, load cell fatigue which decreases its ability to withstand cyclic loading.

Therefore, there is a need for a self-charging load cell to generate power for its components and increase the lifespan of the components.

### SUMMARY

The present general inventive concept provides a self-charging load cell.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a self-charging load cell, including a main body to at least partially deform in response to an application of force thereto, a piezoelectric actuator disposed within at least a portion of the main body to generate power in response to the main body at least partially deforming, and a power unit disposed within at least a portion of the main body to store the power generated by the piezoelectric actuator and transmit the power to an external device.

The piezoelectric actuator may generate the power based on a deformation level of the main body.

The self-charging load cell may further include a capacitor disposed within at least a portion of the main body to receive the power generated by the piezoelectric actuator and transfer the power to the power unit.

The piezoelectric actuator may be a separate component from the main body.

The piezoelectric actuator may be infused as material as part of construction of the main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a self-charging load cell, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Self-Charging Load Cell 100
Main Body 110
Fastener Receiving Apertures 120
Docking Station 130
Computer Docking Slot 130a
Piezoelectric Actuator Docking Slot 130b
Capacitor Docking Slot 130c
Docking Station Screw Receiving Apertures 131
Housing Units 140
Computer Housing Unit 140a
Piezoelectric Actuator Housing Unit 140b
Battery Capacitor Housing Unit 140c
Power Cover 150
Power Cover Screw Receiving Apertures 151
Screws 160

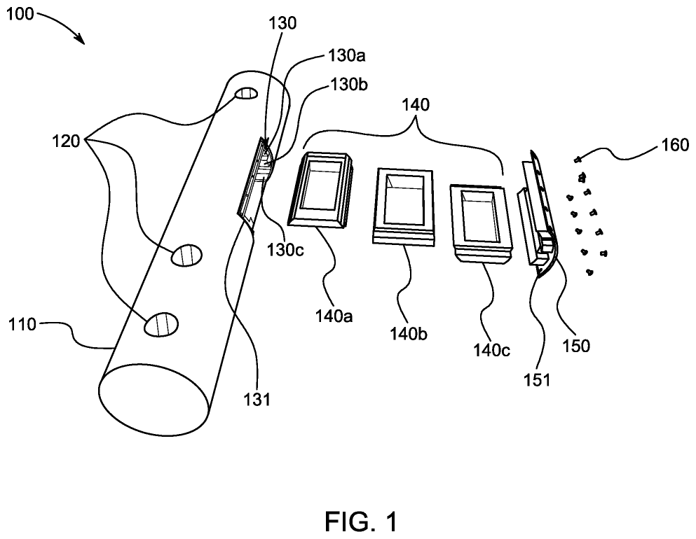

FIG. 1 illustrates a side perspective view of a self-charging load cell 100, according to an exemplary embodiment of the present general inventive concept.

The self-charging load cell 100 may be constructed from at least one of metal, plastic, wood, glass, ceramic, and rubber, etc., but is not limited thereto.

The self-charging load cell 100 may include a main body 110, a plurality of fastener receiving apertures 120, a docking station 130, a plurality of housing Units 140, a power cover 150, and a plurality of screws 160, but is not limited thereto.

Referring to FIG. 1, the main body 110 is illustrated to have a cylindrical shape. However, the main body 110 may be rectangular, circular, triangular, pentagonal, hexagonal, heptagonal, octagonal, or any other shape known to one of ordinary skill in the art, but is not limited thereto.

The main body 110 may be constructed as a load cell. For example, the main body 110 may be a strain gauge, a single point load cell, a planar beam load cell, a bending beam load cell, a ring torsion load cell, a compression load cell, a load pin, a weigh pad, and/or any other type of load cell. Moreover, the main body 110 may at least partially deform (e.g., bend, stretch, expand) in response to an application of force (e.g., pushing, pulling) thereto. Also, the main body 110 may generate a power (e.g., voltage) corresponding to a force level of the application of force.

The plurality of fastener receiving apertures 120 may be disposed on and/or within at least a portion of the main body 110. Each of the plurality of fastener receiving apertures 120 may receive at least one fastener (e.g., a screw, a nail, a bolt, etc.) therethrough. Accordingly, the plurality of fastener receiving apertures 120 may receive the at least one fastener to fasten the main body 110 to an external surface and/or an external object.

The docking station 130 may include a computer docking slot 130a, a piezoelectric actuator docking slot 130b, and a battery capacitor docking slot 130c, but is not limited thereto.

The plurality of housing units 140 may include a computer housing unit 140a, a piezoelectric actuator housing unit 140b, and a battery capacitor housing unit 140c, but are not limited thereto.

The computer housing unit 140a, the piezoelectric actuator housing unit 140b, and the battery capacitor housing unit 140c may all be removably attachable to the computer docking slot 130a, the piezoelectric actuator docking slot 130b, and the battery capacitor docking slot 130c, respectively. Specifically, the computer housing unit 140a may slide in and out of the computer docking slot 130a, the piezoelectric actuator housing unit 140b may slide in and out of the piezoelectric actuator docking slot 130b, and the battery capacitor housing unit 140c may slide in and out of the battery capacitor docking slot 130c.

The computer housing unit 140a may include a computer, such as a central processing unit (CPU) and a communication unit (e.g., a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet), but is not limited thereto.

The computer housing unit 140a may be detachably disposed within at least a portion of the main body 110, and more specifically, within the computer docking slot 130a, and/or may be connected to piezoelectric actuator housing unit 140b and/or the battery capacitor housing unit 140c. The computer housing unit 140a may receive and/or store the power from the battery capacitor housing unit 140c. Additionally, the computer housing unit 140a may transmit (e.g., wirelessly via an electromagnetic field) the power (e.g., voltage) stored thereon to an external device, such as a strain gauge and/or a computing device (e.g., a computer, a mainframe, a terminal, etc.). As such, the computer housing unit 140a may provide the power as needed without exhausting and/or overpowering the external device and/or the main body 110.

The piezoelectric actuator housing unit 140b may include a piezoelectric actuator therewithin that is constructed as crystalline, ceramic, and/or polymeric, but is not limited thereto.

The piezoelectric actuator housing unit 140b may be detachably disposed within at least a portion of the main body 110, and more specifically, within the piezoelectric actuator docking slot 130b. Moreover, the piezoelectric actuator housing unit 140b may generate power in response to the main body 110 at least partially deforming (e.g., bending, vibrating, etc.). In other words, the piezoelectric actuator housing unit 140b may generate a voltage based on a deformation level (i.e., how much the main body 110 has deformed) of the main body 110.

The battery capacitor housing unit 140c may include a battery and/or capacitor housed therewithin, and may be detachably disposed within at least a portion of the main body 110, preferably within the battery capacitor docking slot 130c, and/or may be connected to the piezoelectric actuator housing unit 140b. The battery capacitor docking slot 130c may receive the power generated by piezoelectric actuator housing unit 140b.

The power cover 150 may be removably connected (e.g., snap, fastened, magnetically) to at least a portion of the main body 110. More specifically, the power cover 150 may facilitate access to the housing units 140 in response to being removed (i.e., opened). Conversely, the power cover 150 may prevent access to the housing units 140 in response to being connected (i.e., closed) to the main body 110. As such, the power cover 150 may cover the housing units 140.

The docking station 130 may include a plurality of docking station screw receiving apertures 131 to receive the plurality of screws 160 therein, in order to secure the power cover 150 to the docking station 130, such that the housing units 140 are secured and enclosed within the docking station 130. Specifically, the user may insert the plurality of screws 160 into the plurality of power cover screw receiving apertures 151 of the power cover 150, in order to allow the plurality of screws 160 to further attach to the docking station screw receiving apertures 131 such that the power cover 150 is secured to the main body 110.

Therefore, the self-charging load cell 100 may generate power for the external device and/or components within the main body 110. Also, the self-charging load cell 100 may identify a load based on the power generated.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A self-charging load cell, comprising:
a main body to at least partially deform in response to an application of force thereto;
a computer housing unit comprising at least one of a central processing unit and a communication unit to be removably attached within at least a first portion of the main body;
a piezoelectric actuator housing unit comprising a piezoelectric actuator to be removably attached within at least a second portion of the main body; and
a battery capacitor housing unit comprising at least one of a battery and a capacitor to be removably attached within at least a third portion of the main body.

2. The self-charging load cell of claim 1, wherein the piezoelectric actuator generates the power based on a deformation level of the main body.

3. The self-charging load cell of claim 1, further comprising:
a capacitor disposed within at least a portion of the main body to receive the power generated by the piezoelectric actuator and transfer the power to the power unit.

4. The self-charging load cell of claim 1, wherein the piezoelectric actuator is a separate component from the main body.

5. The self-charging load cell of claim 1, wherein the piezoelectric actuator is infused as material as part of construction of the main body.
